(19) United States
(12) Patent Application Publication
(10) Pub. No.: US 2006/0039731 A1
(43) Pub. Date: Feb. 23, 2006

(54) Arrangement for determination of the heat capacity requirement of a printing material to be applied by the fixing unit of a fixing station in an electrophotographic printer or copier

(76) Inventor: Roland Wolf, Unterhaching (DE)

Correspondence Address: SCHIFF HARDIN LLP;Patent Department, 6600 Sears Tower, 233 South Wacker Drive, Chicago, IL, 60606, US

(21) Appl. No.: 11/197,089

(22) Filed: Aug. 4, 2005

(30) Foreign Application Priority Data
Aug. 23, 2004 (DE) 10 2004 040 777.0

(51) Int. Cl. G03G 15/00

(52) U.S. Cl. 399/389

(57) ABSTRACT

In order to already be able to acceptably affix toner images applied on a print substrate at a beginning of a printing, it is necessary that the heat capacity requirement necessary for this is known. This is dependent on the properties of the print substrate such as its weight, dampness, heat conductivity, etc. A measurement arrangement made up of a reference radiation source and a temperature sensor is provided to determine the heat capacity requirement. The print substrate is irradiated with the reference radiation source. The heat emitted by the print substrate is measured with the temperature sensor. The heat requirement of the print substrate can be determined from the measurement result, for example at a beginning of the printing event.

### BACKGROUND

Electrophotographic printer or copiers, for example laser printing systems, generate (in a known manner) potential images of images to be printed on an intermediate image carrier, for example a photoconductor drum or a photoconductor belt, and ink these with toner. The toner images are then transfer printed onto a print substrate, for example a paper web. In order to permanently bind the toner images with the print substrate, this is guided through a fixing station in which a fixing unit melts the toner images via heat so that they bond with the printing substrate.

Thermal printing fixing (for example from EP 0 593 813 A1) or radiant heat fixing (for example from DE 198 27 210 C1) can be used for fixing. In thermal printing fixing, the print substrate according to EP 0 593 813 A1 is directed over a pre-heating saddle and subsequently between a fixing roller and a pressure roller as a fixing unit. The print substrate (and with it the toner images) is pre-heated by the pre-heating saddle; the actual fixing occurs via the fixing roller and the pressure roller. In the radiant fixing, for example according to DE 198 27 210 C1, the toner images on the print substrate are exposed to the radiant heat, for example of an infrared radiator as a fixing unit.

The requirement for heat capacity to fix the toner images depends on the properties of the print substrate, for example on its weight, its dampness, its absorption property, its heat conductivity, etc. The print substrate weight is taken into account in the thermal printing fixing according to EP 0 593 813 A1. The print substrate weight is input by the operator or is scanned and a signal characterizing the requirement for heat capacity is supplied to a regulation circuit that correspondingly adjusts the temperature of the pre-heating saddle and with it the temperature of the print substrate.

In DE 25 03 953, a radiant heat source is used for fixing the toner images. A radiation detector responding to infrared radiation is fastened at a mounting to receive radiation which is substantially blocked when the medium passes between the radiation detector and the radiant heat source. The output from the radiation detector is used to control energy to the radiant heat source.

### SUMMARY

An object to be solved is to specify an arrangement with which all properties of the print substrate and additionally the environment conditions of the printing device (such as room temperature, environmental humidity) are considered in the setting of the heat capacity requirement of the print substrate, in particular at the beginning of the printing.

In a system or method for determining a heat capacity requirement of a print substrate to be applied by a fixing unit of a fixing station in an electrophotographic printer or copier, a measurement arrangement is provided comprising a reference radiation source and a temperature sensor. The reference radiation source exposes the print substrate to a radiant heat. The temperature sensor measures the heat emitted by the print substrate. An evaluation circuit determines the heat capacity requirement of the print substrate from a result of the measurement.

### BRIEF DESCRIPTION OF THE DRAWINGS

FIG. 1 is a first exemplary embodiment of the invention;

FIG. 2 is a second exemplary embodiment of the invention; and

FIG. 3 is an example for circuits that can be used in the measurement arrangement.

### DESCRIPTION OF THE PREFERRED EMBODIMENTS

For the purposes of promoting an understanding of the principles of the invention, reference will now be made to the preferred embodiments illustrated in the drawings and specific language will be used to describe the same. It will nevertheless be understood that no limitation of the scope of the invention is thereby intended, such alterations and further modifications in the illustrated device, and/or method, and such further applications of the principles of the invention as illustrated therein being contemplated as would normally occur now or in the future to one skilled in the art to which the invention relates.

The preferred embodiments have the advantage that the heat capacity requirement of the print substrate necessary in order to achieve an acceptable fixing of toner images on the print substrate is known.

It is particularly advantageous that the heat capacity requirement can already be known at the beginning of the printing. At this point in time, in unit could be adjusted so that they supply the heat capacity requirement of the print substrate; rather, a lead temperature is pre-set. Only when the printing event has begun and the fixing station is functioning can the actual fixing temperature be measured in the known printing devices and the desired fixing temperature be readjusted corrected from the measurement result.

In a first exemplary embodiment, the reference radiation source and the temperature sensor can be arranged relative to one another such that a region on the print substrate is exposed to a radiant heat and this region is simultaneously measured by the temperature sensor, such that no movement of the print substrate relative to the measurement device is required. For example, a reference radiation source and a temperature sensor can be inclined relative to one another so that the radiant heat impinges on the print substrate at an angle and the temperature sensor measures the reflected radiant heat.

In a second exemplary embodiment, a reference radiation source and a temperature sensor can be arranged relative to one another such that the surface on the print substrate is initially irradiated and is sampled by the temperature sensor after further movement of the print substrate. The reference radiation source and the temperature sensor can then be aligned perpendicular to the print substrate and, in the measurement event, the print substrate can be moved relative to the reference radiation source and the temperature sensor. In a printing device it is practical to utilize the movement of the print substrate that is already provided.

The heating of the print substrate by the reference radiation source is chosen so that no variation of the properties of the print substrate occurs. In this way the later fixing event is not negatively influenced.

Furthermore, it is advantageous when the temperature sensor is aligned so that it samples as a measurement area the middle region of the area of the print substrate irradiated by the reference radiation source. The measurement surface can thereby be selected significantly smaller than the irradiated surface, and with this measurement errors due to non-uniform radiation distribution can be prevented.

The arrangement can be designed so that the reference radiation source is initially activated for the measurement event and is subsequently deactivated again. This can occur via mechanical or electrical switches. The switching should thereby be shorter than the cooling time of the print substrate. The temperature sensor can then measure at least the cool-down curve. Naturally the temperature sensor can then measure both the warm-up curve and the cool-down curve. From the measurement results, for example from the amplitude and/or the slopes of the curves, the evaluation circuit can determine the heat capacity requirement of the print substrate that the fixing unit must apply in the printing event.

The preferred embodiments can be advantageously used when the fixing unit is a radiant heat source. The reference radiation source can then exhibit an emission curve corresponding to that of the radiant heat source. In this case the radiant heat source can also be used as a reference radiation source.

In a printing device, reference radiation source and temperature sensor can be selectably arranged at different locations. For example, they can be arranged before the transfer printing point at which toner images are transferred onto the print substrate. The measurement is then not influenced by the heating of the printing device. It is also possible to arrange the reference radiation source and the temperature sensor adjacent to and before the fixing station. Here, however, the toner allocation on the print substrate and the heat effect of the fixing station are to be taken into account. Naturally, the measurement arrangement can also be arranged such that it can move on the transport path of the print substrate in order to be able to implement the measurement at various points of the transport path. In order to prevent an additional hardware expenditure, a radiator of the radiant heat source can be used as a reference radiator and a sensor present at the output of the fixing station for measurement of the outlet temperature can be used as a temperature sensor.

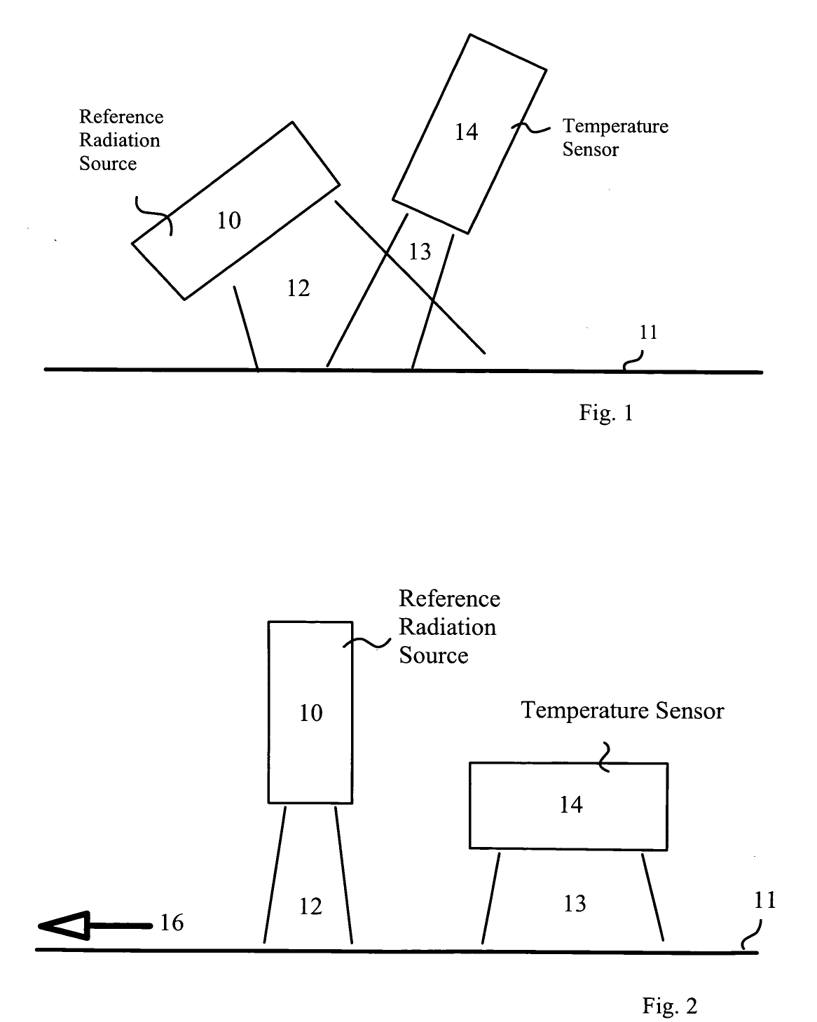

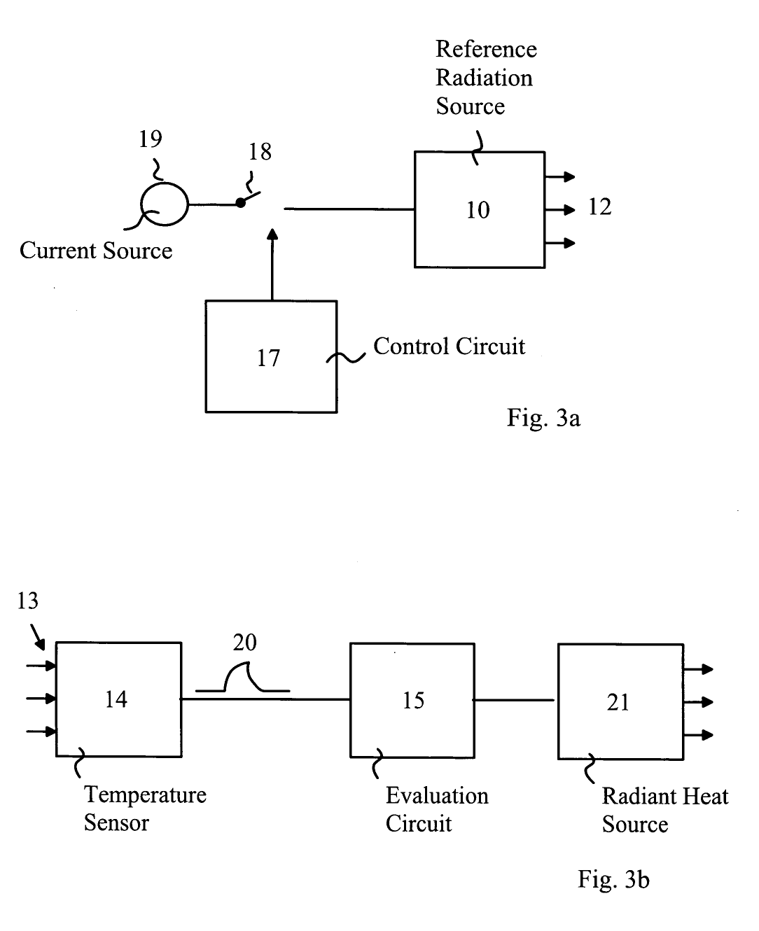

A measurement arrangement made up of a reference radiation source 10 and a temperature sensor 14 that can be used in the preferred embodiment results from FIG. 1. The reference radiation source 10 exposes a print substrate 11, for example a paper web, to a radiant heat 12. The radiant heat 13 emitted by the print substrate 11 is measured by the temperature sensor 14. The measurement result is forwarded from the temperature sensor 14 to an evaluation circuit 15 (FIG. 3). Reference radiation source 10 and temperature sensor 14 are arranged at an angle to one another as an example in FIG. 1. The print substrate 11 is not moved during the measurement. Here the irradiation of the print substrate 11 and the sampling by the temperature sensor 14 occur simultaneously.

FIG. 2 shows a further embodiment of the invention. Here reference radiation source 10 and temperature sensor 14 are arranged perpendicular to the print substrate 11. The print substrate is transported in the direction of the arrow 11. The print substrate is transported in the direction of the arrow 16. Here the irradiation of the print substrate 11 and its sampling occur in succession.

When a fixing station according to DE 198 27 210 C1 (this is referenced in the disclosure) is used, the fixing unit is comprised of a radiant heat source (of course other types of heat sources may be used.). The measurement arrangement then provides particularly precise measurement results since it can be simulated in terms of its emission curve of the radiant heat source. The print substrate 11 is locally heated via a combination made up of radiation density and irradiation time. The reference radiation source 10 is deactivated by means of a mechanism (for example a diaphragm) or electrical switch 17 (FIG. 3). Under the assumption that the switching time of the reference radiation source 10 is shorter than the cool-down time of the print substrate 11, the temperature curve given by the temperature sensor 14 is a measurement of the properties of the print substrate 11. Both the warm-up curve and the cool-down curve, and also the amplitude, may be used to determine the heat capacity requirement; however, the cool-down time alone can also be sufficient for the determination of the heat capacity requirement.

In the exemplary embodiments of FIGS. 1 and 2, the area generated on the print substrate 11 by the reference radiation source 10 is selected larger than the measurement area that the temperature sensor 14 samples. The middle region of the irradiated area is selected as a measurement area in order to prevent measurement errors. The reference radiation source 10 irradiates the print substrate 11 so that the properties of the print substrate 11 are not adversely affected.

In a principle image, FIG. 3 shows circuits that can be used for operation of the measurement arrangement. A possibility to activate the reference radiation source 10 thereby results from FIG. 3a. The reference radiation source 10 is connected with a current source 19 via a switch 18 activated by a control circuit 17. By closing the switch 18, the reference radiation source 10 is fed with current and emits radiant heat 12. By opening the switch 18, the radiant heat is interrupted and the print substrate 11 can cool off. The control of the switch 18 can also be initiated by an operator.

The measurement signals 20 are evaluated by the temperature sensor 14 with the circuit according to FIG. 3b. The temperature sensor 14 emits a measurement curve 20 (temperature plotted over time) that exhibits a rise slope (warm-up curve) with the activation and exhibits a decrease slope (cool-down curve) after the deactivation. The measurement curve is only shown in principle in FIG. 3b. From the measurement curve 20 (for example from its amplitude and/or from the slopes of the warm-up curve and/or the cool-down curve), an evaluation circuit 15 determines the heat capacity requirement that, for example, is to be supplied to the print substrate 11 at the beginning of the printing or after the beginning of the printing. The heat capacity that the radiant heat source 21 must apply is then determined from the heat capacity requirement. This value is supplied to the radiant heat source 21 of the fixing station, for example an IR radiation source.

While preferred embodiments have been illustrated and described in detail in the drawings and foregoing description, the same are to be considered as illustrative and not restrictive in character, it being understood that only the preferred embodiments have been shown and described and that all changes and modifications that come within the spirit of the invention both now or in the future are desired to be protected.

I claim as my invention:

1. A system to determine a heat capacity requirement of a print substrate to be applied by a fixing unit of a fixing station in an electrophotographic printer or copier, comprising:
a measurement arrangement comprising a reference radiation source and a temperature sensor;
the reference radiation source exposing the print substrate to a radiant heat;
the temperature sensor measuring the heat emitted by the print substrate; and
an evaluation circuit that determines said heat capacity requirement of the print substrate from a result of the measurement.

2. A system according to claim 1 in which the reference radiation source and the temperature sensor are arranged relative to one another such that no movement of the print substrate is necessary for said measuring.

3. A system according to claim 2 in which the reference radiation source and the temperature sensor are arranged at an inclination relative to one another so that the radiant heat impinges on the print substrate at an angle and the temperature sensor measures reflected heat rays.

4. A system according to claim 1 in which the reference radiation source and the temperature sensor are arranged relative to one another so that a movement of the print substrate is necessary for said measuring.

5. A system according to claim 4 in which the reference radiation source and the temperature sensor are aligned perpendicular to the print substrate and a relative movement between print substrate and the measurement arrangement is provided for said measuring.

6. A system according to claim 1 in which the measurement arrangement is moveable along a transport path of the print substrate.

7. A system according to claim 1 in which heating of the print substrate by the reference radiation source is such that substantially no variation of properties of the print substrate occurs.

8. A system according to claim 1 in which the temperature sensor is aligned so that a middle region of an area of the print substrate irradiated by the reference radiation source is sampled as a measurement area.

9. A system according to claim 1 in which the reference radiation source is activated for the measuring and is subsequently deactivated, and the temperature sensor measures at least a cool-down curve.

10. A system according to claim 1 in which the reference radiation source is activated for measuring and is subsequently deactivated, and the temperature sensor measures both a warm-up curve and a cool-down curve.

11. A system according to claim 1 in which the fixing unit comprises a radiant heat source and the reference radiation source exhibits an emission curve corresponding to that of the radiant heat source.

12. A system according to claim 11 in which a radiant heat source is used as said reference radiation source.

13. A system according to claim 11 in which a radiant heat source is used as said reference radiation source and a sensor provided at an output of the fixing station to measure a temperature of the print substrate is used as said temperature sensor.

14. A system according to claim 1 in which the measurement arrangement is arranged before a transfer printing location in which toner images are transferred onto the print substrate.

15. A system according to claim 1 in which the measurement arrangement is arranged adjacent to the fixing station.

16. A system according to claim 1 in which the evaluation circuit determines the heat capacity requirement of the print substrate from at least one of an amplitude, a slope of a warm-up curve, or a cool-down curve.

17. A method for determination of a heat capacity requirement of a print substrate to be applied by a fixing unit of a fixing station in an electrophotographic printer or copier, comprising the steps of:
providing a reference radiation source and a temperature sensor;
exposing the print substrate to a radiant heat from the reference radiation source;
with the temperature sensor, measuring the heat emitted by the print substrate; and
determining said heat capacity requirement of the print substrate from a result of the measurement by the temperature sensor.

18. A method according to claim 17 in which the determination of the heat requirement of the print substrate is implemented at a start of the printing event.

19. A method for determination of a heat capacity requirement of a print substrate to be applied by a fixing unit of a fixing station in an electrophotographic printer or copier, comprising the steps of:
providing a reference radiation source and a temperature sensor;
exposing the print substrate to a radiant heat from the reference radiation source;
with the temperature sensor, measuring the heat emitted by the print substrate; and
determining said heat capacity requirement of the print substrate from a result of the measurement by the temperature sensor.

20. A system to determine a heat capacity requirement of a print substrate to be applied by a fixing unit of a fixing station in an electrographic printer or copier, comprising:
a reference radiation source and a temperature sensor, at least said temperature sensor being arranged externally to said fixing station;
the reference radiation source exposing the print substrate to a radiant heat;
the temperature sensor measuring the heat emitted by the print substrate; and
an evaluator determining said heat capacity requirement of the print substrate from a result of the measurement.
